(19) United States
(12) Patent Application Publication
(10) Pub. No.: US 2009/0284167 A1
(43) Pub. Date: Nov. 19, 2009

(54) Dual Level Power Source For Compact Florescent Bulbs

(75) Inventors: Chou Shih Bin, Taipei (TW); Ye Guanlin, Zhejiang (CN); Ye Guanrong, Zhejiang (CN)

Correspondence Address: LIEBERMAN & BRANDSDORFER, LLC, 802 STILL CREEK LANE, GAITHERSBURG, MD, 20878, US

(73) Assignees: CANEL LIGHTING CO. LTD., Dong-Guan City (CN); DESIGN SOLUTIONS INTERNATIONAL, INC., Tamarac, FL (US)

(21) Appl. No.: 12/122,164

(22) Filed: May 16, 2008

(51) Int. Cl. H05B 37/00

(52) U.S. Cl. 315/291

(57) ABSTRACT

A power supply for a compact florescent bulb has an EMC filtering circuit, a power level selection switch a controller and an output for the bulb which is the load for the power supply. The selector switch is used to cause the controller to selectively supply one of two power levels to the florescent bulb.

### BACKGROUND OF THE INVENTION

The present invention relates to florescent lighting. More specifically, the present invention relates to power supplies for florescent light bulbs.

### SUMMARY OF THE INVENTION

It is an object of the present invention to provide a florescent bulb that can be illuminated at more than a single power level. Compact florescent bulbs offer an energy efficient alternative to incandescent lighting but typically operate at a single set wattage and therefore a single set light output level. Fixtures for compact florescent bulbs typically have only an on or off setting to deliver full power or no power to the bulb. Although it is possible to power a florescent bulb at different wattages, because of the limitations of light fixtures, compact florescents must operate at a fixed light output level, unless fixtures and sockets are replaced.

The present invention eliminates the need for replacement of fixtures or sockets while allowing a compact florescent bulb to be illuminated at more than one wattage level, by incorporating a power control circuit into the base of the bulb. The compact florescent bulb of the present invention can be installed into any socket and will still retain the ability to be illuminated at more than one level.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a front perspective view of the present invention.

FIG. 2 is circuit diagram of the power supply of the present invention.

### DETAILED DESCRIPTION OF PREFERRED EXEMPLARY EMBODIMENTS

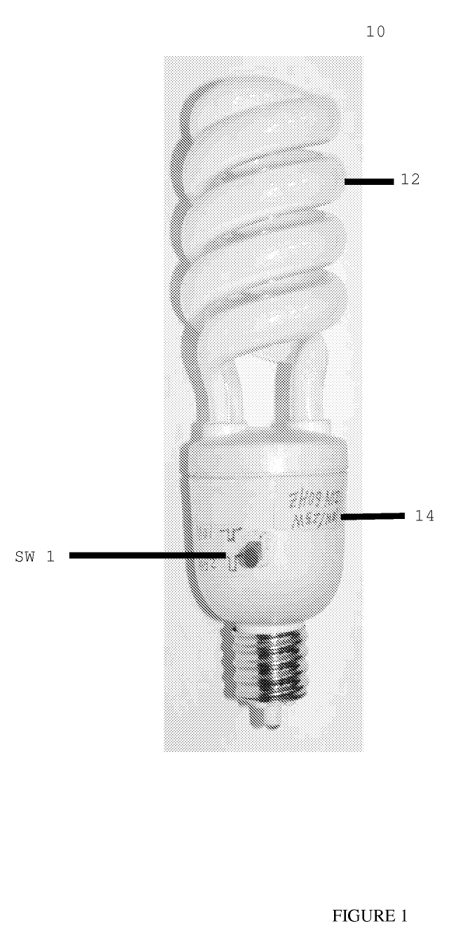

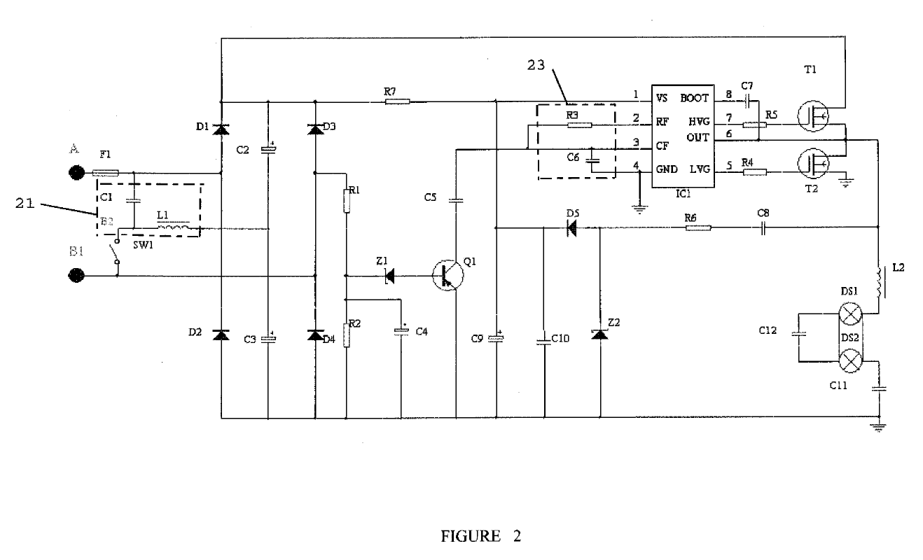

Compact florescent bulb 10, as illustrated in FIG. 1, has a standard florescent tube 12 mounted on a base 14 which includes an internal ballast illustrated in FIG. 2. Instead of a standard single power level ballast, the bulb assembly of the present invention includes a dual power level ballast which, in the exemplary embodiment, can deliver either 10 Watts or 25 Watts to the florescent tube.

The lamp 12 is attached at DS1 and DS2 and receives power which is attached to the circuit at A and B. Switch SW1, illustrated in FIGS. 1 and 2, is used to connect input B to the circuit for power to the lamp 12. The power selection is thus controlled by the is selective actuation of switch SW1. As illustrated in FIG. 1, switch SW1 is mounted on the plastic part of the lamp base 14 within access by the user of the compact florescent bulb.

The power circuit, FIG. 2, includes an EMC filtering circuit 21 which, in the exemplary embodiment, includes capacitor C1 and inductor L1. The EMC circuit 21 restrains the conducting disturbance from the florescent lamp, thus the performance of conducting disturbance can attain the requirement (CISPR 15 EN55015) of electronic disturbance of the IEC.

The power circuit also includes an integrating circuit IC1 used to control the two power drive transformers T1 and T2. The frequency of the power applied is determined by RC circuit 23 formed from external capacitance and resistance (C6 and R3):

F=The frequency should be matched with frequency of output-side.

L—the induction of T1. C12 condenser

Actuation of changing switch SW1 changes the circuit between providing a working on full-wave rectification and a double-voltage rectification, so that the two ways power can be obtained. At the condition of the double-voltage rectification, when switch SW1 is closed, Z1 will be conducted, and Q1 will be also conducted. The external CF will be the combination of C6 and C5 as C5 is pulled into the circuit by the conduction of Q1. The frequency thus becomes lower because of the increased capacitance of the RC circuit, and the lamp power reaches the maximum power.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

We claim:

1. A dual level power source for compact florescent bulbs, comprising:
a circuit having a first power setting for providing power at a first wattage level; and
a second power setting for providing power at a second wattage level,
wherein said circuit is incorporated into the base of a compact florescent bulb.

2. The dual level power source of claim 1, wherein:
said first power level is 10 Watts, and
said second power level is 25 Watts.

3. The dual level power source of claim 1, wherein:
said circuit is configured for providing power from a power source to said compact florescent bulb, wherein said power sources is alternating current; and said circuit comprises:
a user actuated switch to selectively alternate between said first power setting and said second power setting.

4. The dual level power source of claim 3, wherein said switch is mounted on said base of said compact florescent bulb, within access of the user of the compact florescent bulb.

5. The dual level power source of claim 1, wherein:
said power circuit includes an EMC filtering circuit

6. The dual level power source of claim 5, wherein:
said EMC filtering circuit includes a capacitor and an inductor.

7. The dual level power source of claim 5, wherein:
said power circuit further include:
two power drive transformers; and
an integrating circuit used to control said power drive transformers at a selectable frequency of actuation.

8. The dual level power source of claim 7, wherein:
the frequency of the power applied to said bulb is determined by an RC circuit.

9. The dual level power source of claim 8, wherein:
selection between said first and second power settings is accomplished by a change in the capacitance of said RC circuit actuation

10. The dual level power source of claim 9, wherein:
said selection between said first and second power settings is accomplished by providing a working on full-wave rectification for said first power setting and a double-voltage rectification for said second power setting.

11. The dual level power source of claim 9, wherein:
an increase in said capacitance of said RC circuit increases the power to said bulb.

12. The dual level power source of claim 8, wherein:
said power circuit further includes a transistor switched to increase said capacitance of said RC circuit to reduce the frequency of said actuation by said integrated circuit to provide increased power to said bulb.
